(19) United States
(12) Patent Application Publication
(10) Pub. No.: US 2020/0142876 A1
(43) Pub. Date: May 7, 2020

(54) SYSTEMS AND METHODS FOR SPATIAL INDEX

(71) Applicant: BEIJING DIDI INFINITY TECHNOLOGY AND DEVELOPMENT CO., LTD., Beijing (CN)

(72) Inventors: Hua CHEN, Beijing (CN); Xudong ZHANG, Beijing (CN)

(73) Assignee: BEIJING DIDI INFINITY TECHNOLOGY AND DEVELOPMENT CO., LTD., Beijing (CN)

(21) Appl. No.: 16/733,273

(22) Filed: Jan. 3, 2020

Related U.S. Application Data
(63) Continuation of application No. PCT/CN2017/093146, filed on Jul. 17, 2017.

(51) Int. Cl. G06F 16/22; G06F 16/23

(52) U.S. Cl. CPC G06F 16/2246; G06F 16/2343; G06F 16/2264; G06F 16/2282

(57) ABSTRACT

The present disclosure relates to systems and methods for determining a quadtree associated with a region. The systems may perform the methods to: encode a region including a plurality of sub-regions; generate a quadtree with respect to the encoded region, wherein the quadtree includes a plurality of layers and a plurality of nodes, and wherein each of the plurality of nodes corresponds to at least one of the plurality of sub-regions; and determine a plurality of link tables associated with the quadtree, wherein each of the plurality of link tables corresponds to one of the plurality of nodes, and wherein a second link table corresponding to a second node is affiliated to a first link table corresponding to a first node which is a parent node of the second node at an upper layer of the quadtree.

### CROSS-REFERENCE TO RELATED APPLICATIONS

This application is a continuation of International Application No. PCT/CN2017/093146, filed on Jul. 17, 2017, which designates the United States of America, the contents of which are incorporated herein by reference in their entirety.

### TECHNICAL FIELD

The present disclosure generally relates to systems and methods for on-demand service, and in particular, to systems and methods for processing on-demand services based on spatial index.

### BACKGROUND

On-demand transportation services utilizing Internet technology, such as online taxi services, have become increasingly popular because of their convenience. A system providing on-demand services should dynamically determine or update reference information (e.g., the number of available service providers within an area) associated with on-demand services. However, in some situations, it may be difficult to determine or update the reference information efficiently when the reference information changes rapidly with time.

### SUMMARY

According to a first aspect of the present disclosure, a system is provided. The system may include at least one storage medium and at least one processor in communication with the at least one storage medium. The at least one storage medium may include a set of instructions for determining a quadtree associated with a region. When executing the set of instructions, the at least one processor may be directed to perform one or more of the following operations. The at least one processor may encode a region including a plurality of sub-regions. The at least one processor may generate a quadtree with respect to the encoded region, wherein the quadtree may include a plurality of layers and a plurality of nodes. Each of the plurality of nodes may correspond to at least one of the plurality of sub-regions. The at least one processor may determine a plurality of link tables associated with the quadtree, wherein each of the plurality of link tables may correspond to one of the plurality of nodes. A second link table corresponding to a second node may be affiliated to a first link table corresponding to a first node which is a parent node of the second node at an upper layer of the quadtree.

According to a second aspect of the present disclosure, a method is provided. The method may be implemented on a computing device having at least one processor, at least one storage medium, and a communication platform connected to a network. The method may include one or more of the following operations. The at least one processor may encode a region including a plurality of sub-regions. The at least one processor may generate a quadtree with respect to the encoded region, wherein the quadtree may include a plurality of layers and a plurality of nodes. Each of the plurality of nodes may correspond to at least one of the plurality of sub-regions. The at least one processor may determine a plurality of link tables associated with the quadtree, wherein each of the plurality of link tables may correspond to one of the plurality of nodes. A second link table corresponding to a second node may be affiliated to a first link table corresponding to a first node which is a parent node of the second node at an upper layer of the quadtree.

According to a third aspect of the present disclosure, a non-transitory computer readable medium is provided. The non-transitory computer readable medium may include a set of instructions for determining a quadtree associated with a region. When executed by at least one processor, the set of instructions may direct the at least one processor to perform one or more of the following acts. The at least one processor may encode a region including a plurality of sub-regions. The at least one processor may generate a quadtree with respect to the encoded region, wherein the quadtree may include a plurality of layers and a plurality of nodes. Each of the plurality of nodes may correspond to at least one of the plurality of sub-regions. The at least one processor may determine a plurality of link tables associated with the quadtree, wherein each of the plurality of link tables may correspond to one of the plurality of nodes. A second link table corresponding to a second node may be affiliated to a first link table corresponding to a first node which is a parent node of the second node at an upper layer of the quadtree.

In some embodiments, the at least one processor may encode each of the plurality of sub-regions based on a geometry library.

In some embodiments, the second link table corresponding to the second node may be affiliated to the first link table corresponding to the first node which is a parent node of the second node at an upper layer of the quadtree via an invalid location included in the first link table.

In some embodiments, each of the plurality of layers may include a plurality of read-write locks which can be shared by the plurality of link tables.

In some embodiments, a state of the read-write lock may include a read state or a write state.

In some embodiments, the at least one processor may access the first node corresponding to the first link table. The at least one processor may determine a state of a first read-write lock of the first link table as a write state. The at least one processor may access the second node corresponding to the second link table. The at least one processor may determine a state of a second read-write lock of the second link table as the write state. The at least one processor may change the state of the first read-write lock of the first link table from the write state to the read state.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device according to some embodiments of the present disclosure;

FIG. 3 a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process for reading/writing information associated with objects in a region according to some embodiments of the present disclosure;

FIG. 6 is a block diagram illustrating an exemplary determination module according to some embodiments of the present disclosure;

FIG. 7 is a flowchart illustrating an exemplary process for determining a spatial quadtree index according to some embodiments of the present disclosure;

FIG. 8 is a schematic diagram illustrating an exemplary spatial quadtree index according to some embodiments of the present disclosure;

FIG. 9 is a block diagram illustrating an exemplary read-write module according to some embodiments of the present disclosure;

FIG. 10 is a flowchart illustrating an exemplary writing process associated with a quadtree according to some embodiments of the present disclosure; and

FIG. 11 is a schematic diagram illustrating an exemplary quadtree according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding on-demand transportation service, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for transmitting and/or receiving an express. The application scenarios of the system or method of the present disclosure may include a web page, a plug-in of a browser, a client terminal, a custom system, an internal analysis system, an artificial intelligence robot, or the like, or any combination thereof.

The terms “passenger,” “requestor,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The term “service request” in the present disclosure refers to a request that initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

Online on-demand transportation services, such as online taxi hailing, is a new form of service rooted only in post-Internet era. Further, real-time determining the number of available taxi service providers and the number of pending service requests within an area is a technology problem raises only in the post-Internet era.

An aspect of the present disclosure relates to systems and methods for determining and/or updating information (e.g., the number of available service providers within an area, the number of pending service requests within an area) associated with on-demand services based on spatial index. The systems and methods may encode a region and construct a spatial quadtree index based on the encoded region. The quadtree may include a plurality of nodes corresponding to a plurality of sub-regions of the region. The systems and methods may further determine a plurality of link tables corresponding to the plurality of nodes. Therefore, the systems and methods may determine or update information associated with a sub-region by reading and/or writing a corresponding link table. Via the spatial quadtree index, it becomes efficient to determine or update the information associated with on-demand services.

With the development of Internet technology, online to offline services (e.g., taxi-hailing services) have become increasingly popular. For different regions and/or different time periods, service information (e.g., a count of service providers, a count of service requests to be allocated, a count of pending service requests) may be dynamically and frequently changed. In order to ensure that service requests can be allocated efficiently and accurately, an online service platform should quickly and efficiently update the service information. According to the systems and methods of the present disclosure, as described above, a quadtree is determined by encoding a region, wherein the quadtree includes a plurality of nodes corresponding to a plurality of sub-regions. Via the spatial quadtree index, an area can be quickly identified and service information within the area can be accordingly determined or updated, thereby improving the efficiency of the service request allocation.

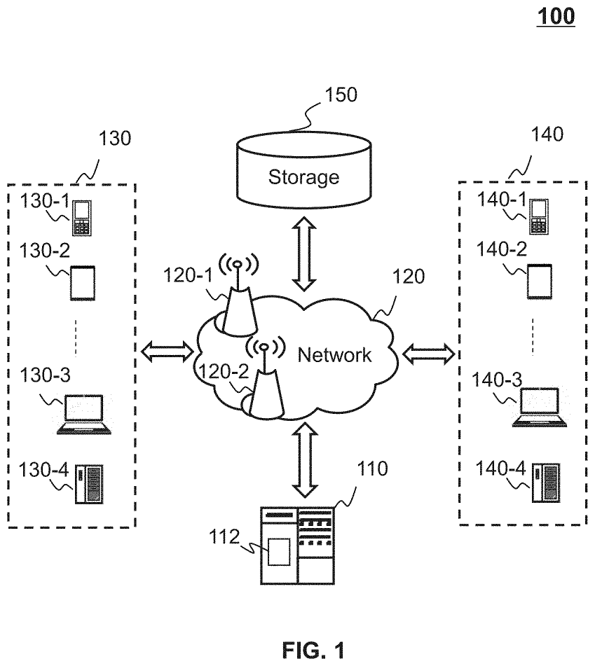

FIG. 1 is a schematic diagram of an exemplary on-demand service system 100 according to some embodiments of the present disclosure. For example, the on-demand service system 100 may be an online transportation service platform for transportation services such as taxi hailing, chauffeur services, delivery vehicles, carpool, bus service, driver hiring, and shuttle services. The on-demand service system 100 may be an online platform including a server 110, a network 120, a requester terminal 130, a provider terminal 140, and a storage 150. The server 110 may include a processing engine 112.

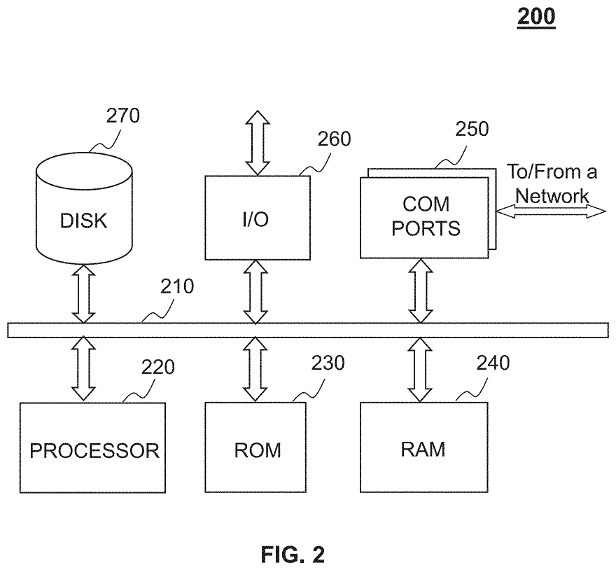

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the storage 150 via the network 120. As another example, the server 110 may connect the requestor terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a quadtree associated with a region. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 100 (e.g., the server 110, the requestor terminal 130, the provider terminal 140, and the storage 150) may transmit information and/or data to other component(s) in the on-demand service system 100 via the network 120. For example, the server 110 may receive a service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information between them.

In some embodiments, a requestor may be a user of the requestor terminal 130. In some embodiments, the user of the requestor terminal 130 may be someone other than the requestor. For example, a user A of the requestor terminal 130 may use the requestor terminal 130 to transmit a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with another positioning device to determine the position of the requestor, the requestor terminal 130, the provider, and/or the provider terminal 140. In some embodiments, the requestor terminal 130 and/or the provider terminal 140 may transmit positioning information to the server 110.

The storage 150 may store data and/or instructions. In some embodiments, the storage 150 may store data obtained from the requestor terminal 130 and/or the provider terminal 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requestor terminal 130, the provider terminal 140). One or more components in the on-demand service system 100 may access the data or instructions stored in the storage 150 via the network 120. In some embodiments, the storage 150 may be directly connected to or communicate with one or more components in the on-demand service system 100 (e.g., the server 110, the requestor terminal 130, the provider terminal 140). In some embodiments, the storage 150 may be part of the server 110.

In some embodiments, one or more components of the on-demand service system 100 (e.g., the server 110, the requestor terminal 130, the provider terminal 140) may access the storage 150. In some embodiments, one or more components of the on-demand service system 100 may read and/or modify information relating to the requester, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

It should be noted that the application scenario illustrated in FIG. 1 is only provided for illustration purposes, and not intended to limit the scope of the present disclosure. For example, the on-demand system 100 may be used as a navigation system.

FIG. 2 is a schematic diagram illustrating exemplary hardware and software components of a computing device 200 on which the server 110, the requester terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

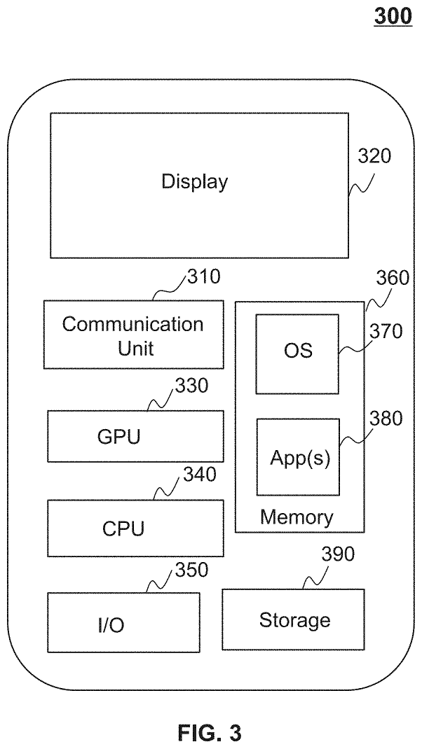

FIG. 3 is a schematic diagram illustrating exemplary hardware and/or software components of an exemplary mobile device 300 on which the requester terminal 130 or the provider terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™ Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to an order for service or other information from the location based service providing system on the mobile device 300. User interactions with the information stream may be achieved via the I/O devices 350 and provided to the processing engine 112 and/or other components of the system 100 via the network 120.

To implement various modules, units, and their functionalities described in the present disclosure, computer hardware platforms may be used as the hardware platform(s) for one or more of the elements described herein (e.g., the on-demand service system 100, and/or other components of the on-demand service system 100 described with respect to FIGS. 1-11). The hardware elements, operating systems and programming languages of such computers are conventional in nature, and it is presumed that those skilled in the art are adequately familiar therewith to adapt those technologies to the management of the supply of service as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

One of ordinary skill in the art would understand that when an element of the on-demand service system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

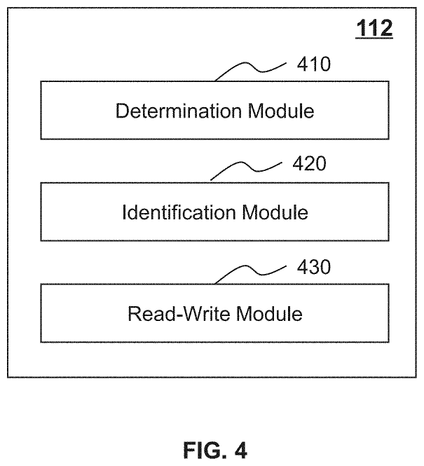

FIG. 4 is a block diagram illustrating an exemplary processing engine 112 according to some embodiments of the present disclosure. The processing engine 112 may include a determination module 410, an identification module 410, and a read-write module 430.

The determination module 410 may be configured to determine a quadtree (also referred to as a “spatial quadtree index”) associated with a region. The quadtree may be a tree structure which may be used to analyze, classify, and/or process spatial data (e.g., a location point in two-dimensional space). The quadtree may include a plurality of nodes and the node may include four sub-nodes. The region may be a predetermined geographic area (e.g., a square area with a predetermined side length).

In some embodiments, the determination module 410 may encode the region and construct a quadtree based on the encoded region. For example, the determination module 410 may divide the region into a plurality of sub-regions, and each of the plurality of sub-regions may be expressed by a code. Further, the determination module 410 may construct the quadtree based on a plurality of codes corresponding to the plurality of sub-regions. In some embodiments, the quadtree may include a plurality of nodes, the determination module 410 may further determine a plurality of link tables corresponding to the plurality of nodes.

The identification module 420 may be configured to identify a target region. The target region may include one or more objects (e.g., an available service provider, a pending service request, a service request to be allocated).

In some embodiments, the identification module 420 may identify the target region from the plurality of sub-regions. For example, after receiving a service request, the identification module 420 may determine a start location of the service request and identify a circle area within a certain radius (e.g., a default value such as 500 meters, 1 km) from the start location. Further, the identification module 420 may identify a sub-region corresponding to the circle area as the target region. As another example, the identification module 420 may identify a sub-region as the target region based on instructions from the on-demand service system 100 or from a user.

The read-write module 430 may be configured to determine (also referred to as “read”) and/or update (also referred to as “write”) information associated with the object(s) in the target region based on the quadtree. For example, the read-write module 430 may determine the number of available service providers in the target region by reading the plurality of link tables associated with the quadtree. As another example, the read-write module 430 may update the number of pending service requests in the target region by writing the plurality of link tables associated with the quadtree.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the determination module 410 and the identification module 420 may be combined as a single module which may both determine a quadtree associated with a region and identify a target region. As another example, the processing engine 112 may include a storage module (not shown) used to store data and/or information of the region, the plurality of sub-regions, the quadtree, the target region, information associated with object(s) in the target region, etc,

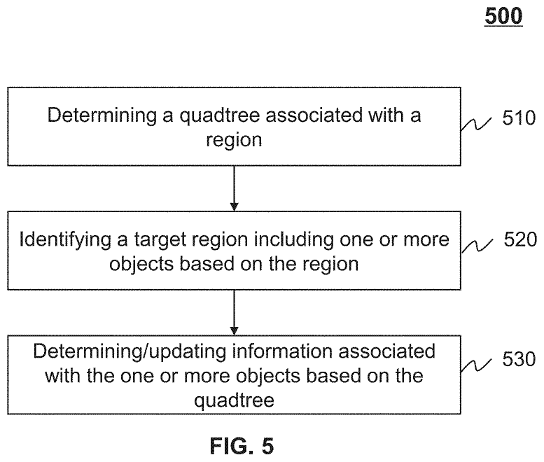

FIG. 5 is a flowchart illustrating an exemplary process for executing spatial index according to some embodiments of the present disclosure. The process 500 may be executed by the on-demand service system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In 510, the interface circuits of the processing engine 112 may access a storage medium (e.g., the ROM 230, the RAM 240) to load structured data of a set of instructions for determining a quadtree associated with a region. The processing engine 112 (e.g., the processing circuits of the processing engine 112) (e.g., the determination module 410) may determine a quadtree associated with a region (e.g., a square area with a predetermined side length) by executing the set of instructions.

The processing engine 112 may determine the quadtree based on a geometry library (e.g., Google S2 library). For example, the processing engine 112 may divide the region into a plurality of sub-regions and encode the plurality of sub-regions based on the geometry library (e.g., Google S2 library). The quadtree may include a plurality of (e.g., 30) layers including, a root layer, a plurality of intermediate layers, and a leaf layer. The root layer may include a root node corresponding to the region. Each of the plurality of intermediate layers may include a plurality of intermediate nodes, and each of the plurality of intermediate nodes corresponds to a sub-region of the region.

In some embodiments, the processing engine 112 may further determine a plurality of link tables corresponding to the plurality of nodes of the quadtree. As used herein, a link table may include one or more locations, each location may represent an object in the sub-region corresponding to the link table.

In 520, the processing engine 112 (e.g., the processing circuits of the processing engine 112) (e.g., the identification module 420) may identify a target region including one or more objects. The processing engine 112 may identify the target from the plurality of sub-regions of the region.

As used herein, the object may refer to an available vehicle (or an available service provider), a pending service request, a service request to be allocated, etc. The available service provider may refer to a service provider that can provide a service at the present moment.

In some embodiments, the object may be represented as a location point in the target region. The processing engine 112 may determine the location point according to a GPS integrated in the requester terminal 130 or the provider terminal 140. For example, the processing engine 112 may obtain GPS information from the provider terminal 140 via the network 120 and further determine a GPS point corresponding to the provider terminal 140.

In 530, the processing engine 112 (e.g., the processing circuits of the processing engine 112) (e.g., the read-write module 430) may determine and/or update information associated with the one or more objects based on the quadtree.

In some embodiments, the information associated with the one or more objects may include the number of the one or more objects (e.g., the number of available service providers in the target region), location information of the one or more objects (e.g., longitude and latitude information), detail information (e.g., a type of an available vehicle, a start location and/or a destination of a service request) of the one or more objects, etc.

In some embodiments, the processing engine 112 may determine and/or update the information associated with the one or more objects by reading and/or writing a link table corresponding to the target region.

For example, if a specific provider moves into the target region, the processing engine 112 may add a new location to a link table corresponding to the target region to increase the number of available service providers by “1,” As another example, if a pending service request is terminated, the processing engine 112 may determine that the service request has been completed and delete a location from a link table corresponding to the target region to decrease the number of pending service requests by “1.” As a further example, if a requester sends a service request to the on-demand service system 100, the processing engine 112 may receive the service request and read a link table (e.g., determine the number of locations in the link table) corresponding to the target region to determine the number of available service providers in the target region.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 500. In the storing step, the processing engine 112 may store the quadtree, the plurality of link tables, the target region, and/or the information associated with the object(s) in the target region in a storage device (e.g., the storage 150) disclosed elsewhere in the present disclosure.

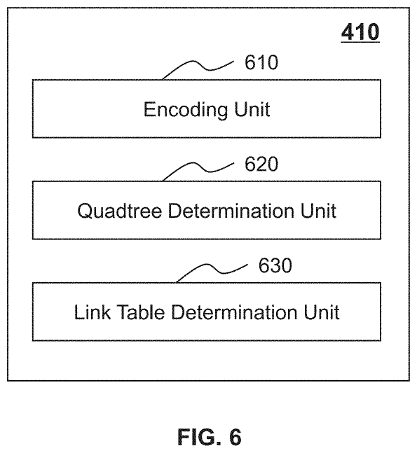

FIG. 6 is a block diagram illustrating an exemplary determination module 410 according to some embodiments of the present disclosure. The determination module 410 may include an encoding unit 610, a quadtree determination unit 620, and a link table determination unit 630.

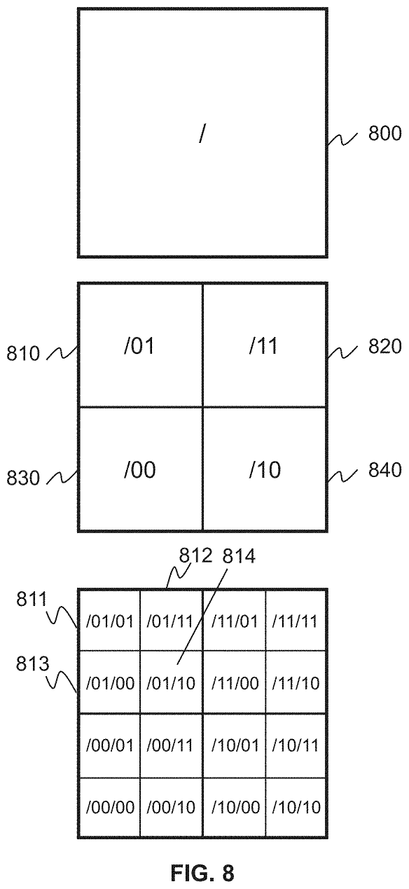

The encoding unit 610 may be configured to encode data and/or information of a region. The encoding unit 610 may encode the region by dividing the region into a plurality of sub-regions (e.g., see FIG. 8 and the description thereof). For example, the encoding unit 610 may divide the region into equal four sub-regions, and each of the sub-regions may be further divided into four sub-regions, and so on. Each of the plurality of sub-regions may be expressed by a code. For example, the encoding unit 610 may encode the region based on a geometry library (e.g., Google S2 library), and each of the plurality of sub-regions may be expressed by a 64-bit code.

The quadtree determination unit 620 may be configured to determine a quadtree based on the encoded region. The quadtree may include a plurality of layers including a root layer, a plurality of intermediate layers, and a leaf layer. In some embodiments, if the region is encoded based on the geometry library, the number of the plurality of layers in the quadtree may be 30. The quadtree may include a plurality of nodes including a root node and a plurality of sub-nodes at different layers. The root node may correspond to the region and the plurality of sub-nodes may correspond to the plurality of sub-regions.

The link table determination unit 630 may be configured to determine a plurality of link tables corresponding to the plurality of nodes in the quadtree. A link table may include one or more locations, and each of the one or more locations may represent an object in a sub-region (or the region) corresponding to the link table. In some embodiments, a link table corresponding to a node may include a plurality of invalid locations, and link tables corresponding to sub-nodes of the node may be affiliated to the link table via the plurality of invalid locations.

The units in the determination module 420 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single unit, and any one of the units may be divided into two or more sub-units.

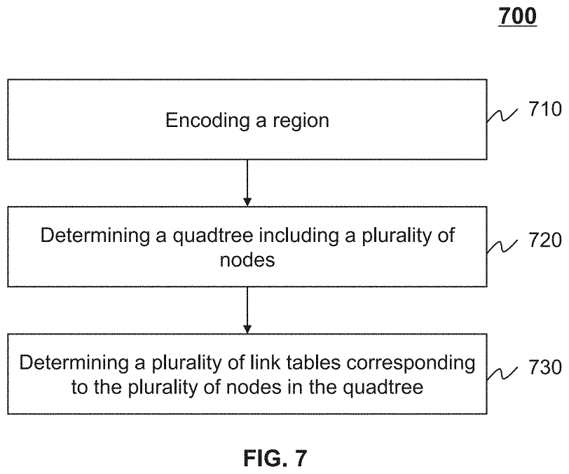

FIG. 7 is a flowchart illustrating an exemplary process for determining a spatial quadtree index according to some embodiments of the present disclosure. The process 700 may be executed by the on-demand service system 100. For example, the process 700 may be implemented as a set of instructions (e.g., an application) stored in the storage ROM 230 or RAM 240. The processor 220 may execute the set of instructions, and when executing the instructions, it may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process as illustrated in FIG. 7 and described below is not intended to be limiting.

In 710, the processing engine 112 (e.g., the processing circuits of the processing engine 112) (e.g., the encoding unit 610) may encode a region. For example, the processing engine 112 may encode the region based on a geometry library (e.g., Google S2 library). According to the Google S2 library, the processing engine 112 may divide the region into a plurality of sub-regions, wherein each of the plurality of sub-regions may be expressed by a 64-bit code.

In 720, the processing engine 112 (e.g., the processing circuits of the processing engine 112) (e.g., the quadtree determination unit 620) may determine a quadtree based on the encoded region.

The quadtree may include a plurality of layers including a root layer, a plurality of intermediate layers, and a leaf layer. If the region is encoded based on the Google S2 library, the number of the plurality of layers in the quadtree may be 30. The quadtree may include a plurality of nodes at different layers. For example, the root layer (i.e., a first layer) may include a root node, a second layer (i.e., a first intermediate layer which is a sub-layer of the root layer) may include four nodes, and so on, an ith layer may include 4ⁱ⁻¹ nodes, where 1≤i≤30. Here, the root node may correspond to the region and the plurality of sub-nodes may correspond to the plurality of sub-regions.

In 730, the processing engine 112 (e.g., the processing circuits of the processing engine 112) (e.g., the link table determination unit 630) may determine a plurality of link tables corresponding to a plurality of nodes in the quadtree. A link table may include one or more locations, and each of the one or more locations may represent an object in a sub-region (or the region) corresponding to the link table. In some embodiments, a link table M corresponding to a node M may be affiliated to a link table N corresponding to a node N which is a parent node of the node M. In this situation, the link table N may include a plurality of invalid locations. The link table M may be affiliated to the link table N via an invalid location in the link table N. For example, assuming that the sub-region corresponding to the node M includes 3 objects, therefore, the link table M includes 3 locations representing the 3 objects. The link table M may point to the link table N via an invalid location and 3 locations following the invalid location in the link table N may represent the 3 objects. Similarly, link tables corresponding to other sub-nodes of the node N may be affiliated to the link table N via other invalid locations in the link table N.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, if the number of the objects in a sub-region corresponding to a specific node at an ith layer is only 1, the sub-nodes of the specific node may be hidden and the branch of the quadtree may be simplified. As another example, if new objects are added to the sub-region (e.g., new available service providers move into the sub-region), the number of the objects in the sub-region may increase. In this situation, the sub-nodes of the specific node may be unhidden and the branch may be grown back.

FIG. 8 is a schematic diagram illustrating an exemplary spatial quadtree index according to some embodiments of the present disclosure.

As shown in FIG. 8, a region 800 may correspond to a root layer of a quadtree. The region 800 may be divided into four even sub-regions including 810, 820, 830, and 840 which correspond to four nodes respectively at a second layer of the quadtree. Further, each of the sub-regions 810, 820, 830, and 840 may be divided into four even sub-regions. For example, the sub-region 810 may be divided into four sub-regions including 811812, 813, and 814 which correspond to four nodes at a third layer of the quadtree.

In some embodiments, each of the sub-regions may be expressed by a 64-bit code. A sub-region may be identified by two bits in the 64-bit code. For example, the sub-region 810 may be identified by “/01.” The sub-region 810 may be further divided into four even sub-regions 811, 812, 813, and 814 which may be identified by “/01/01,” “01/11,” “/01/00,” and “/01/10” respectively.

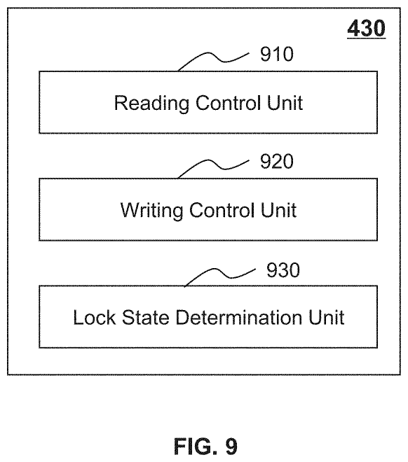

FIG. 9 is a block diagram illustrating an exemplary read-write module 430 according to some embodiments of the present disclosure. As shown in FIG. 9, the read-write module 430 may include a reading control unit 910, a writing control unit 920, and a lock state determination unit 930.

The reading control unit 910 may be configured to read a link table corresponding to a node of the quadtree. As used herein, “read a link table” may refer to that the reading control unit 910 may search for information associated with objects in a sub-region corresponding to the link table. For example, after receiving a service request from the requester terminal 130, the processing engine 112 may identify a start location of the service request and determine a circle area within a certain radius from the start location. The processing engine 112 may further determine a sub-region corresponding to the circle area and determine the number of available service providers in the sub-region by reading a link table (e.g., determining the number of locations in the link table) corresponding to the sub-region.

The writing control unit 920 may be configured to write a link table corresponding to a node of the quadtree. As used herein, “write a link table” may refer to that the writing control unit 920 may update information associated objects in a sub-region corresponding to the link table. For example, after a pending service request is terminated, the processing engine 112 may determine that the service has been completed and update the number of pending service requests within a specific sub-region by modifying (i.e., writing) a link table corresponding to the sub-region. For example, the processing engine 112 may delete a location from the link table, in this situation, the number of locations in the link table decreases by “1.”. Further, as described above, the link table corresponding to the node is affiliated to a link table corresponding to a parent node of the node at an upper layer of the quadtree via an invalid location. In this situation, after the number of the locations decreasing by “1,” the processing engine 112 may identify the link table corresponding to the parent node via the invalid location and update the link table accordingly.

As another example, after an available service provider moves into the sub-region, the processing engine 112 may update the number of available service providers within the sub-region by modifying (i.e., writing) the link table corresponding to the sub-region. For example, the processing engine 112 may add a new location into the link table. Accordingly, the processing engine 112 may further identify a link table corresponding to a parent node of the node via an invalid location and update the link table accordingly.

The lock state determination unit 930 may be configured to determine a state of a read-write lock associated with a node. As used herein, the read-write lock may be used to control the reading and/or writing of a link table corresponding to a node of the quadtree. The state of the read-write lock may include a read state and a write state. In some embodiments, the processing engine 112 may read or write the link tables corresponding to the plurality of nodes through a plurality of threads. When the read-write lock of a link table is under read state, it may indicate that any of the plurality of threads can read the link table at the present moment. When the read-write lock of the link table is under write state, it may indicate that a thread may be writing the link table and other threads cannot read or write the link table at the present moment.

In some embodiments, the processing engine 112 may set a plurality of read-write locks for the plurality of link tables corresponding to the plurality of nodes in the quadtree. For example, for a link table corresponding to the root node, the processing engine 112 may provide only one read-write lock. As another example, the processing engine 112 may provide four read-write locks for four link tables corresponding to the four nodes at the second layer (i.e., the first intermediate layer). As a further example, the processing engine 112 may provide 1024 read-write locks for 4ⁱ⁻¹ (i≥5) link tables corresponding to the 4ⁱ⁻¹ (i≥5) nodes at the ith layer, and the 1024 read-write locks may be shared by the 4ⁱ⁻¹ link tables at the ith layer.

The units in the read-write module 430 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single unit, and any one of the units may be divided into two or more sub-units.

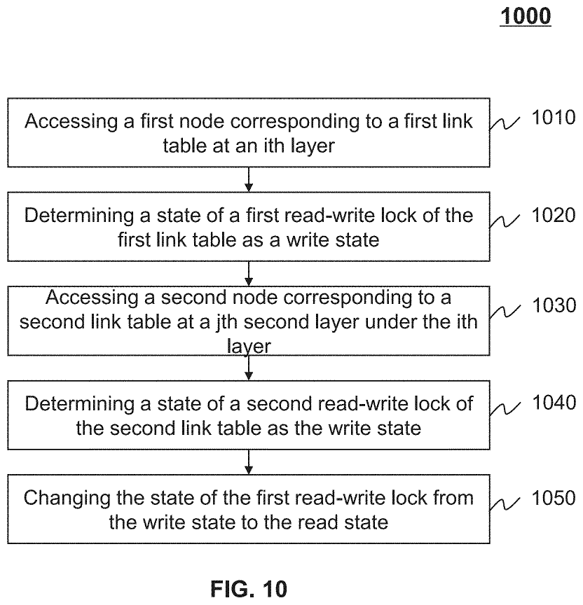

FIG. 10 is a flowchart illustrating an exemplary process for writing the spatial index according to some embodiments of the present disclosure. The process 1000 may be executed by the on-demand service system 100. For example, the process 1000 may be implemented as a set of instructions (e.g., an application) stored in the storage ROM 230 or RAM 240. The processor 220 may execute the set of instructions, and when executing the instructions, it may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting.

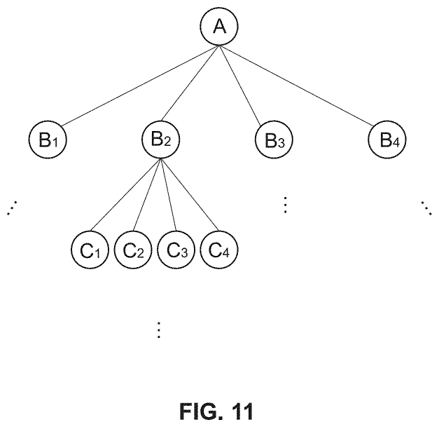

It should be noted that when the processing engine 112 intends to read or write a specific link table (e.g., determine or update the number of available service providers in a sub-region corresponding to the specific link table), the processing engine 112 may crawl the quadtree from the root node layer by layer until reaches to a node corresponding to the specific link table. During the crawling process, the processing engine 112 may access the nodes layer by layer along a branch (e.g., from node A to node B₂ and further to node C₂ illustrated in FIG. 11) in the quadtree. The description below takes a writing process as an example, and is not intended to limit the scope of the present disclosure.

In 1010, a thread of the processing engine 112 (e.g., the processing circuits of the processing engine 112) (e.g., the writing control unit 920) may access a first node at an ith layer corresponding to a first link table.

In 1020, the thread (e.g., the lock state determination unit 930) may determine a state of a first read-write lock of the first link table as a write state. As used herein, the write state indicates that the first link table cannot be read or written by other threads.

In 1030, the thread (e.g., the writing control unit 920) may access a second node at a jth layer corresponding to a second link table. As used herein, the jth layer is under the ith layer and the second node is a sub-node of the first node.

In 1040, the thread (e.g., the lock state determination unit 930) may determine a state of a second read-write lock of the second link table as a write state. The write state here indicates that the second link table cannot be read or written by other threads.

In 1050, the thread (e.g., lock state determination unit 930) may change the state of the first read-write lock from the write state to a read state. As used herein, since the thread has crawled over the first node and reaches to the second node, the first node and other sub-nodes of the first node can be accessed by other threads now.

Each thread of the processing engine 112 may dynamically change the states of the read-write locks of the nodes at different layers until the thread reaches to a node corresponding to the specific link table that the thread intends to write.

It should be noted that the above description of writing the spatial index is provided for the purpose of illustration, and not intended to limit the scope of the present disclosure. For persons having ordinary skills in the art, various variations and modifications may be conducted under the teaching of the present disclosure. However, those variations and modifications may not depart from the spirit and scope of the present disclosure. For example, step 1010 and step 1020 may be executed simultaneously. As another example, step 1040 and 1050 may be executed simultaneously.

FIG. 11 is a schematic diagram illustrating an exemplary quadtree according to some embodiments of the present disclosure. As illustrated in FIG. 11, if a thread intends to write a link table corresponding to node C₂, the thread may first determine a state of a read-write lock of link table A corresponding to node A (i.e., the root node) as a write state. In this situation, link table A and link tables corresponding to all the sub-nodes of node A cannot be read or written by other threads.

Then the thread crawls to node B₂, the thread may determine a state of a read-write state of link table B₂ corresponding to node B₂ as a write state and simultaneously or successively change the state of the read-write lock of link table A as a read state. In this situation, link table B₂ and link tables corresponding to all the sub-nodes of node B₂ cannot be read or written by other threads, and link tables corresponding to the nodes B₁, B₃, and B₄ can be read or written by other threads.

Further, the thread crawls to node C₂, the thread may determine a state of a read-write state of link table C₂ corresponding to node C₂ as a write state and simultaneously or successively change the state of the read-write lock of link table B₂ as a read state. In this situation, link table C₂ and link tables corresponding to all the sub-nodes of node C₂ cannot be read or written by other threads, and link tables corresponding to the nodes C₁, C₃, and C₄ can be read or written by other threads.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system comprising:
at least one storage medium including a set of instructions for determining a quadtree associated with a region;
at least one processor in communication with the at least one storage medium, wherein when executing the set of instructions, the at least one processor is directed to:
encode a region including a plurality of sub-regions;
generate a quadtree with respect to the encoded region, the quadtree including a plurality of layers and a plurality of nodes, wherein,
each of the plurality of nodes corresponds to at least one of the plurality of sub-regions; and
determine a plurality of link tables associated with the quadtree, each of the plurality of link tables corresponding to one of the plurality of nodes, wherein,
a second link table corresponding to a second node is affiliated to a first link table corresponding to a first node which is a parent node of the second node at an upper layer of the quadtree.

2. The system of claim 1, wherein to encode a region including a plurality of sub-regions, the at least one processor is directed to:
encode each of the plurality of sub-regions based on a geometry library.

3. The system of claim 1, wherein the second link table corresponding to the second node is affiliated to the first link table corresponding to the first node which is a parent node of the second node at an upper layer of the quadtree via an invalid location included in the first link table.

4. The system of claim 1, wherein each of the plurality of layers includes a plurality of read-write locks which can be shared by the plurality of link tables.

5. The system of claim 4, wherein a state of the read-write lock includes a read state or a write state.

6. The system of claim 5, wherein the at east one processor is further directed to:
access the first node corresponding to the first link table;
determine the state of a first read-write lock of the first link table as the write state;
access the second node corresponding to the second link table;
determine the state of a second read-write lock of the second link table as the write state; and
change the state of the first read-write lock of the first link table from the write state to the read state.

7. A method implemented on a computing device having at least one processor, at least one storage medium, and a communication platform connected to a network, comprising:
encoding, by the at least one processor, a region including a plurality of sub-regions;
generating, by the at least one processor, a quadtree with respect to the encoded region, the quadtree including a plurality of layers and a plurality of nodes, wherein,
each of the plurality of nodes corresponds to at east one of the plurality of sub-regions; and
determining, by the at least one processor, a plurality of link tables associated with the quadtree, each of the plurality of link tables corresponding to one of the plurality of nodes, wherein,
a second link table corresponding to a second node is affiliated to a first link table corresponding to a first node which is a parent node of the second node at an upper layer of the quadtree.

8. The method of claim 7, further comprising:
encoding, by the at least one processor, each of the plurality of sub-regions based on a geometry library.

9. The method of claim 7, wherein the second link table corresponding to the second node is affiliated to the first link table corresponding to the first node which is a parent node of the second node at an upper layer of the quadtree via an invalid location included in the first link table.

10. The method of claim 7, wherein each of the plurality of layers includes a plurality of read-write locks which can be shared by the plurality of link tables.

11. The method of claim 10, wherein a state of the read-write lock includes a read state or a write state.

12. The method of claim 7, further comprising:
accessing, by the at least one processor, the first node corresponding to the first link table;
determining, by the at least one processor; the state of a first read-write lock of the first link table as the write state;
accessing, by the at least one processor, the second node corresponding to the second link table;
determining, by the at least one processor, the state of a second read-write lock of the second link table as the write state; and
changing, by the at least one processor, the state of the first read-write lock of the first link table from the write state to the read state.

13. A non-transitory computer readable medium, comprising a set of instructions for determining a quadtree associated with a region; wherein when executed by at least one processor, the set of instructions directs the at least one processor to perform acts of:
encoding, by the at least one processor, a region including a plurality of sub-regions;
generating, by the at least one processor, a quadtree with respect to the encoded region, the quadtree including a plurality of layers and a plurality of nodes, wherein,
each of the plurality of nodes corresponds to at feast one of the plurality of sub-regions; and
determining, by the at least one processor, a plurality of link tables associated with the quadtree, each of the plurality of link tables corresponding to one of the plurality of nodes, wherein,
a second link table corresponding to a second node is affiliated to a first link table corresponding to a first node which is a parent node of the second node at an upper layer of the quadtree.

14. The non-transitory computer readable medium of claim 13, wherein the set of instructions further directs the at least one processor to perform acts of:
encoding, by the at least one processor, each of the plurality of sub-regions based on a geometry library.

15. The non-transitory computer readable medium of claim 13, wherein the second link table corresponding to the second node is affiliated to the first link table corresponding to the first node which is a parent node of the second node at an upper layer of the quadtree via an invalid location included in the first link table.

16. The non-transitory computer readable medium of claim 13, wherein each of the plurality of layers includes a plurality of read-write locks which can be shared by the plurality of link tables.

17-18. (canceled)

19. The system of claim 1, wherein the at least one processor is further directed to:
identify a target region from the plurality of sub-regions, the target region including one or more objects; and
update information associated with the one or more objects based on the quadtree.

20. The system of claim 19, wherein the one or more objects include at least one of an available service provider, a pending service request, or a service request to be allocated.

21. The method of claim 7, wherein the method further includes:
identifying a target region from the plurality of sub-regions, the target region including one or more objects; and
updating information associated with the one or more objects based on the quadtree.

22. The method of claim 21, wherein the one or more objects include at least one of an available service provider, a pending service request, or a service request to be allocated.
